(19) United States
(12) Patent Application Publication
(10) Pub. No.: US 2020/0028252 A1
(43) Pub. Date: Jan. 23, 2020

(54) IMPEDANCE LOADED GROUND PLANES FOR IMPROVED ANTENNA PERFORMANCE AND METHODS

(71) Applicant: Taoglas Group Holdings Limited, San Diego, CA (US)

(72) Inventors: Xiaoyan Yuan, San Diego, CA (US); Jeffrey Keith Shamblin, San Marcos, CA (US)

(21) Appl. No.: 16/518,699

(22) Filed: Jul. 22, 2019

Related U.S. Application Data
(60) Provisional application No. 62/701,809, filed on Jul. 22, 2018.

(51) Int. Cl. H01Q 1/48; H01Q 9/04; H01Q 1/38

(52) U.S. Cl. CPC H01Q 1/48; H01Q 1/38; H01Q 9/0421

(57) ABSTRACT

Disclosed are impedance loaded ground plane configurations suitable for use with a wide variety of antennas. The impedance loaded ground plane allows the antenna-ground plane combination to achieve a small form factor without sacrificing the performance or efficiency of the antenna.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Reduction in antenna efficiency for internal antennas coupled to ground planes can occur when single or dual resonance antennas are coupled to ground planes formed by the ground layer of, for example, a host printed circuit board (PCB) of a device integrating an antenna. For frequencies below 1000 MHz, the efficiency of the internal antenna may be reduced when the ground plane length is less than 100 mm. When a ground plane is too short for efficient antenna operation, a technique that is used to compensate for the loss in efficiency is to place a parasitic element at an end of the ground plane opposite the location of the antenna. This technique provides a narrow band effect, but requires fabrication and installation of a second component to the PCB.

### SUMMARY

Certain antenna systems described herein include an antenna configurable to operate in a range of 600 MHz to 1000 MHz having an efficiency greater than 70% in operation; and a ground plane having a length from an attachment location of the antenna to a farthest edge of the ground plane less than 100 mm, wherein the antenna is electrically connected to the ground plane. Additionally, in some configurations, the ground plane can include an LC circuit. A plurality of slots can be provided which are positioned on the ground plane. In some configurations, a capacitor is added to an inductor such that the LC circuit is at least one of a series LC circuit or a parallel LC circuit and further wherein the LC circuit is positioned across a slot of the plurality of slots. Additionally, at least one of a capacitor and a resistor can be provided on the ground plane. The LC circuit can include an L-shaped slot and an inductor. Two or more inductors can be provided wherein the two or more inductors are attached across an L-shaped slot at two or more locations along the length of the L-shaped slot. The L-shaped slot is also configurable in some configurations to disconnect a first portion of the ground plane from a second portion of the ground plane. The antenna can also be connected to a transmission line. The transmission line can have a length of from 2 mm to about 60 mm. The ground plane can have a first dimension of about 35 mm or less and a second dimension of about 80 mm or less. The antenna can have a low frequency resonance and a high frequency resonance. An LC circuit that is provided can further comprises a plurality of slots positioned on the ground plane and/or an L-shaped slot and an inductor.

Another aspect of the disclosure is directed to a ground plane for use with an antenna including a ground plane having an exterior length less than 120 mm; a first slot in the ground plane extending from a first location of the ground plane and a second slot adjacent a portion of the first slot extending from a second location of the ground plane. The ground plane can have a first dimension of from about 35 mm and a second dimension of less than about 80 mm. The ground plane can have a shape selected from square, rectangular, hexagonal, pentagonal, circular, and oval. The ground plane can also have an irregular shape, including for example a shape having more than 5 sides.

Still another aspect of the disclosure is directed to a ground plane for use with an antenna comprising: a ground plane having an exterior length less than 100 mm; and a first slot in the ground plane extending from a first location of the ground plane and a second slot extending from a second location perpendicular the first location of the ground plane. In some configurations, a first slot is linear and a second slot is I-shaped. The first slot can also electromagnetically couple with the second slot. The ground plane can have a first dimension of from about 35 mm and a second dimension of less than 80 mm.

Yet another aspect of the disclosure is directed to a ground plane for use with an antenna comprising: a ground plane having a length and a width, a first edge, a second edge, a third edge, and a fourth edge, wherein the length is less than 120 mm; and an LC circuit comprising a slot and an inductor. The ground plane can have a first dimension of from about 35 mm and a second dimension of less than about 80 mm.

Another aspect of the disclosure is directed to a method of optimizing a ground plane for use with an antenna comprising: selecting a shape of the ground plane; identifying an antenna position on the ground plane wherein the antenna position is near an edge of the ground plane; determining an electrical length of the ground plane from the antenna position to a location on the ground plane farthest from the antenna position; and positioning one or more slots on the ground plane between the antenna position and the location on the ground plane farthest from the antenna position. Additionally, the method can include positioning an LC circuit on the ground plane and, in some aspects, selecting a bandwidth for the LC circuit wherein the bandwidth is selected to optimize a low band frequency for the antenna without decreasing efficiency of a high band frequency.

### BRIEF DESCRIPTION OF THE DRAWINGS

The features of the various embodiments described herein are set forth with particularity in the appended claims. A better understanding of the features and advantages of such embodiments will be obtained by reference to the following detailed description that sets forth illustrative embodiments, in which the principles of the various embodiments are utilized, and the accompanying drawings.

FIG. 1A illustrates a plot of measured antenna efficiency for an exemplar antenna.

FIG. 1B illustrates an exemplar antenna.

FIG. 2A illustrates a narrow-band IoT (NB-IoT) antenna positioned on a 35 mm by 115 mm ground plane.

FIGS. 2B-C illustrate the return loss and total efficiency of the NB-IoT antenna of FIG. 2A.

FIG. 3A illustrates an NB-IoT antenna positioned on a 35 mm by 80 mm ground plane.

FIGS. 3B-C illustrate the return loss and total efficiency of the NB-IoT antenna of FIG. 3A.

FIG. 4A illustrates an NB-IoT antenna positioned on a 35 mm by 80 mm ground plane with horizontal slots.

FIGS. 4B-C illustrate the return loss and total efficiency of the NB-IoT antenna of FIG. 4A.

FIGS. 5A-B illustrate an NB-IoT antenna positioned on a 35 mm by 80 mm ground plane with reduced transmission lines.

FIGS. 5C-D illustrate the return loss and total efficiency of the NB-IoT antennas of FIGS. 5A-B.

FIGS. 6A-B illustrate an NB-IoT antenna positioned on a 35 mm by 80 mm ground plane with a single inductor.

FIGS. 6C-D illustrate the return loss and total efficiency of the NB-IoT antennas of FIGS. 6A-B.

FIGS. 7A-B illustrate an NB-IoT antenna positioned on a 35 mm by 80 mm ground plane with reduced transmission lines.

FIGS. 7C-D illustrate the return loss and total efficiency of the NB-IoT antennas of FIGS. 7A-B.

FIG. 8A illustrates an NB-IoT antenna positioned on a 35 mm by 80 mm ground plane with horizontal slots;

FIGS. 8B-C illustrate the return loss and total efficiency of the NB-IoT antenna of FIG. 8A.

FIGS. 9A-G illustrate a variety of ground plane shapes and slot configurations according to the disclosure.

### DETAILED DESCRIPTION

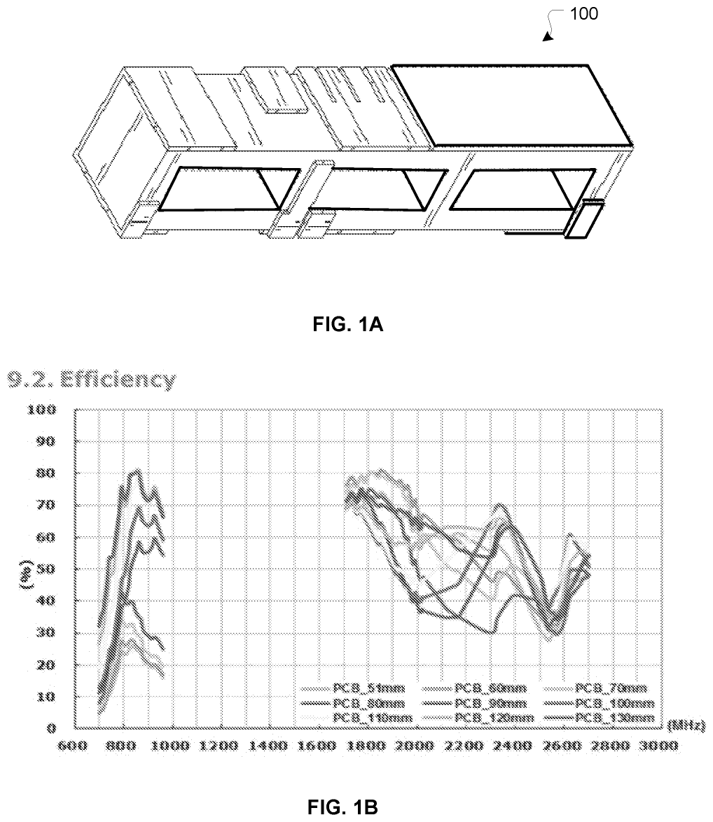

FIG. 1A illustrates an antenna 100 similar to the antenna described in U.S. Pat. No. 9,755,310 B2, which is incorporated by reference herein in its entirety. The antenna 100 can, for example, be a ten-frequency band antenna on a carrier, such as a ceramic carrier, with a high-frequency segment and a low frequency segment. A plurality of blind holes, as illustrated, can be provided. Antennas, such as the antenna 100 in FIG. 1A can be connected to a PCB or a ground plane. However, as noted above, the efficiency of the antenna may change depending on the length of the ground plane.

FIG. 1B illustrates a plot of measured antenna efficiency for an antenna, such as the antenna illustrated in FIG. 1A, on a demo board over a wide range of lengths. The antenna efficiency is reduced as the ground plane length is reduced from 130 mm in length to 51 mm in length. Additionally, the change in efficiency as it relates to the length of the board varies depending on the frequency of the antenna. For example, for a dual band antenna such as antenna 100, changes in length impact efficiency for the low band frequency differently than the high band frequency, as illustrated in FIG. 1B. The change in efficiency based on length of the ground plane ultimately negatively impacts size of the installation for the antenna.

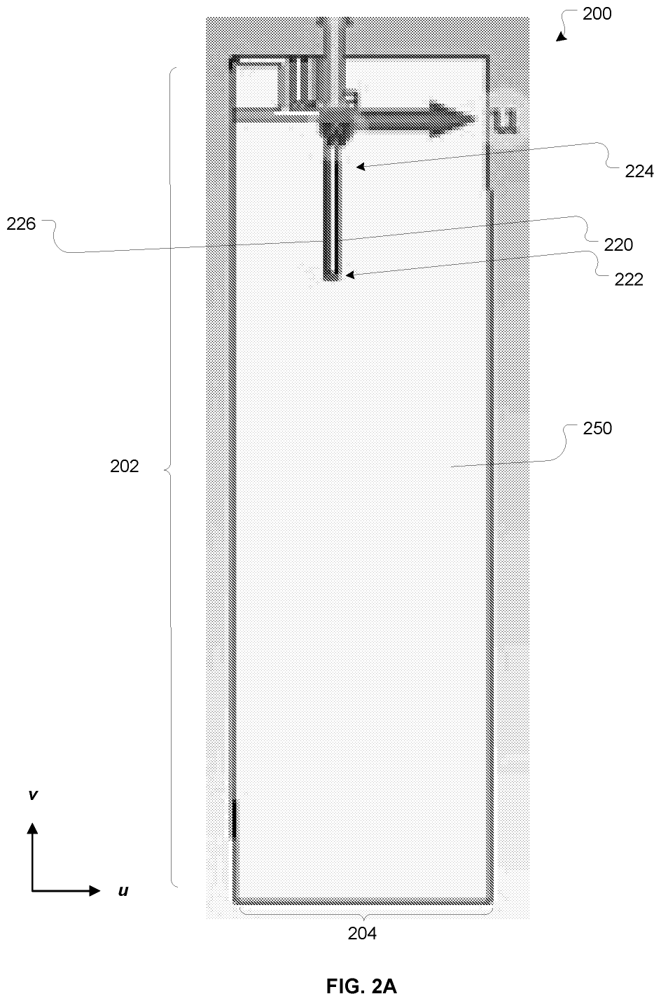

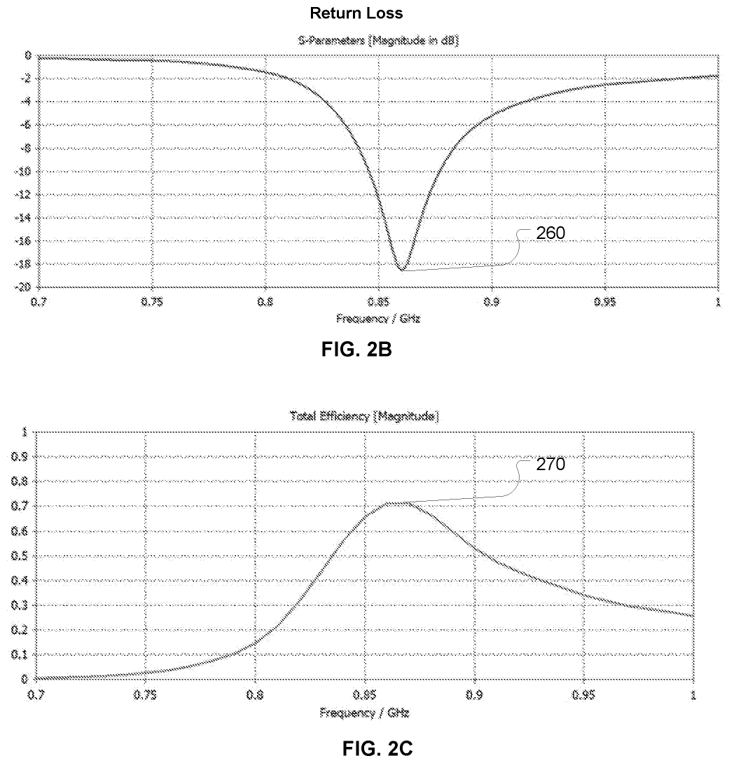

FIG. 2A illustrates a narrow-band IoT (NB-IoT) antenna 200 positioned on a ground plane 250 having a length 202 of 115 mm and a width 204 of 35 mm in an exemplar v-u plane, with the w axis extending out of the page. The exterior length of the ground plane is the sum of the length and widths of the sides, or 300 mm in a perimeter length (e.g., length of the exterior edge of the ground plane) with an area (length×width) of 4025 mm². An elongated transmission line 220 is provided that has a front section 222 and a rear section 224. The front section 222 has a gap 226 between the front section 222 and the first and the ground plane 250. The transmission line is about 21.7 mm in length and is electrically connected to the antenna. As illustrated in FIGS. 2B-C, the antenna 200 has an 18 dB return loss 260 at 860 MHz, and an efficiency 270 of 71%. The antenna 200 is well matched to the ground plane 250.

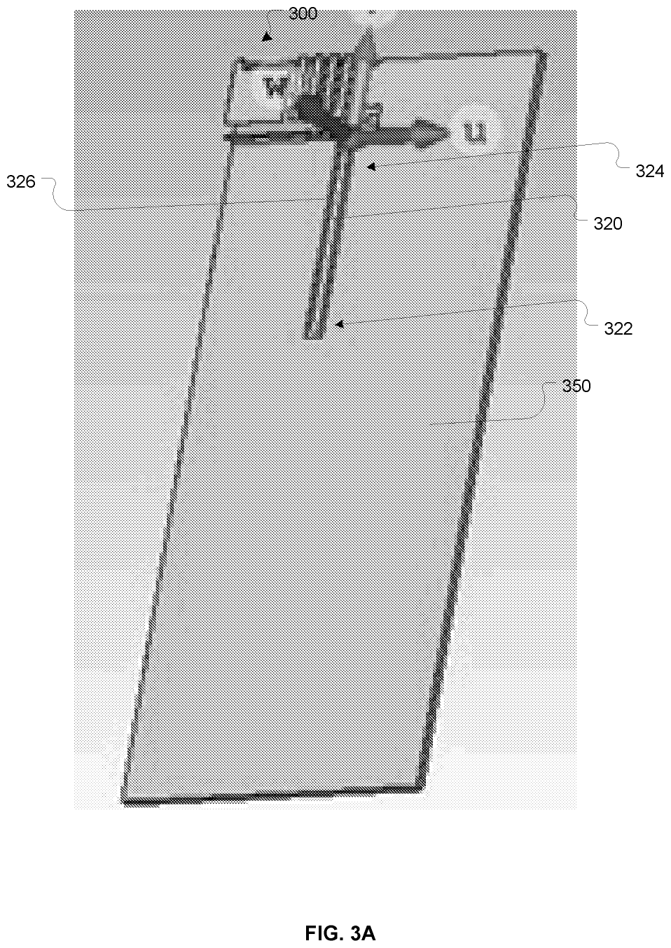

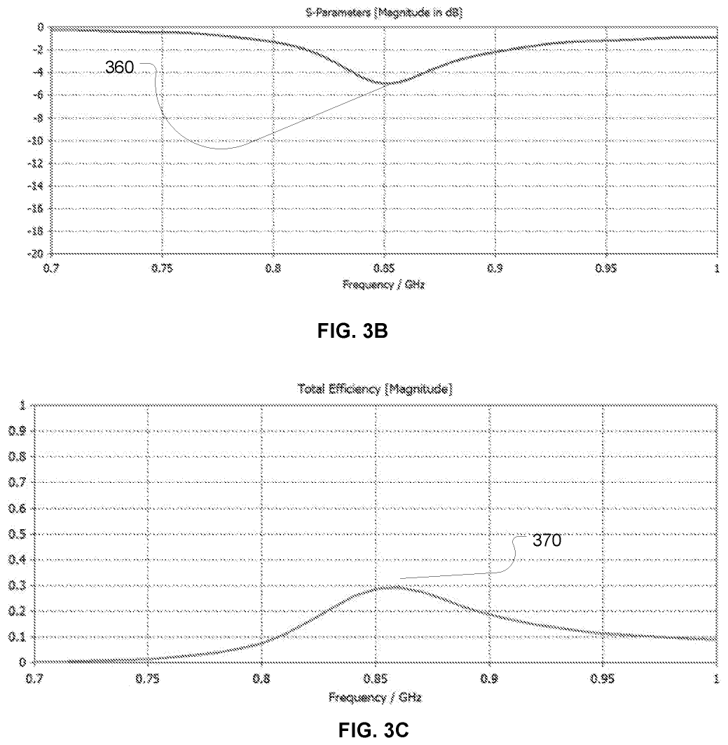

FIG. 3A illustrates a narrow-band IoT (NB-IoT) antenna 300 positioned on a ground plane 350 having a length of 80 mm and a width of 35 mm. The exterior length of the ground plane is the sum of the length and widths of the sides, or 230 mm in a perimeter length with an area (length×width) of 2800 mm². An elongated transmission line 320 is provided that has a front section 322 and a rear section 324. A gap 326 is positioned between the elongated transmission line 320 and the ground plane 350. As illustrated in FIGS. 3B-C, the antenna 300 has a 5 dB return loss 360 at 850 MHz, and an efficiency 370 of 29%, which could be as great as 38% when mismatch loss is accounted for. Reducing the length of the ground plane from 115 m (FIG. 2A) to 80 mm (FIG. 3A), thus reducing the exterior length of the ground plane and the area of the ground plane negatively impact the performance of the antenna.

Described herein are antenna configurations, systems and methods having a ground plane which can be deployed in small spaces without negatively impacting performance of the antenna. Techniques are also described to reduce a decrease in antenna efficiency of an internal antenna coupled to a ground plane that typically occurs when the ground plane length is reduced. The related methods disclosed below have been developed and both bring benefits to the performance of the antenna being addressed.

The efficiency of an antenna placed next to a ground plane that is shortened in length is improved by adding a slot geometry to the ground plane which increases an electrical length of the ground plane. Adding a slot geometry allows for optimized antenna performance without an increase in the ground plane length or the addition of a parasitic element. The increase in efficiency of the antenna results in a more reliable communication link and higher data rates for the system.

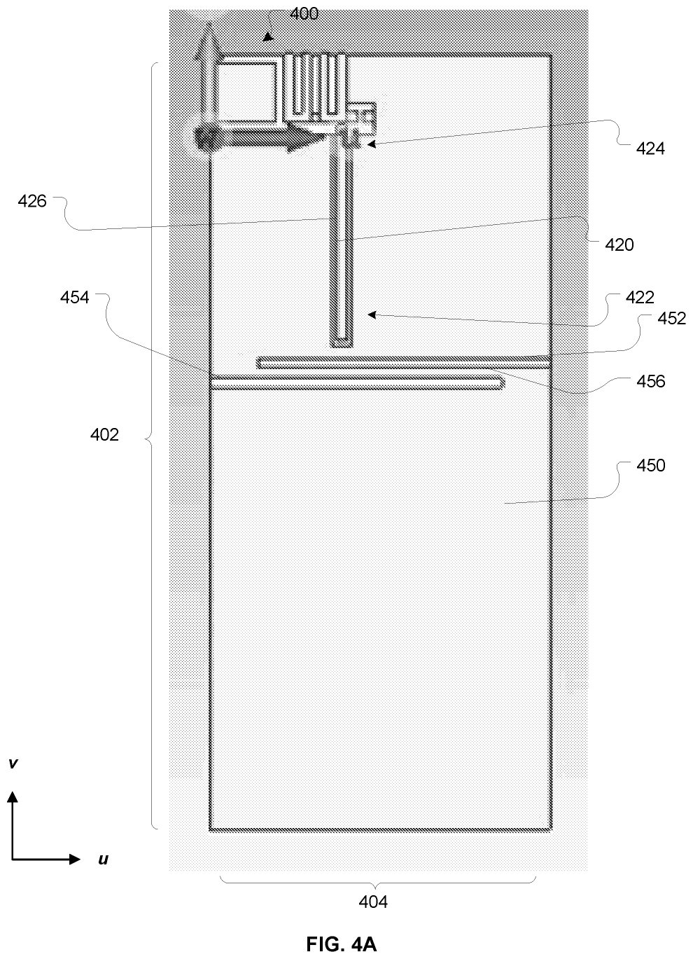

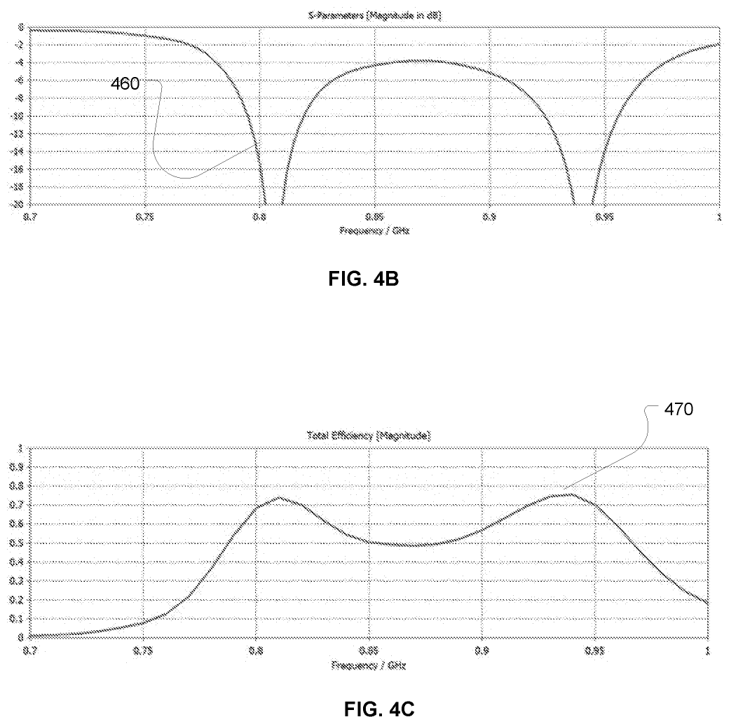

Certain embodiments described herein described with respect to NB-IoT antennas. However, as will be appreciated by those skilled in the art, the disclosed modifications of electrical length can be applied to any antenna where a small installation environment is necessary or desirable. These include, but are not limited to, machine-to-machine (M2M), IoT, cellphones and wearable devices. The NB-IoT is a low power wide area networked radio technology that enables a wide range of cellular devices and services. Advantages of NB-IoT include low power consumption and better range than standards using an unlicensed band. As will be appreciated by those skilled in the art, disclosure of the ground plane and antennas with reference to planes and direction is provided for illustrating relative orientations illustrated and actual planes and directions can vary during implementation without departing from the scope of the disclosure. For purposes of illustration, the planes and axis are the u-axis (e.g., which is depicted from right to left across the page in the view of FIG. 4A), the v-axis (e.g., which is depicted from top to bottom of the page in the view of FIG. 4A) and w-axis (e.g., which is depicted extending out of the plane of the page in the view of FIG. 4A).

Turning to FIG. 4A, a ceramic NB-IoT antenna 400 is illustrated on a ground plane 450 having a length 402 of 80 mm and a width 404 of 35 mm in an u-v plane. The ground plane 450 also includes a first u-axis slot 452 extending from a right side of the ground plane 450 and a second u-axis slot 454 extending from the left side of the ground plane 450 below the first horizontal slot 452.

By using one or more non-bisecting slots, such as the two slots illustrated in FIG. 4A, the RF currents that flow on the ground plane to travel a further distance from the antenna location to reach the end of the ground plane that is farthest from the antenna location. Using two slots that are partially parallel one another generates a target amount of capacitance. Thus, the width of the conductor between the slots will generate a specific amount of inductance. Additionally, the length of the two slots is chosen so that the overlap region between the two slots generates a specific amount of inductance. The combination of capacitance and inductance forms a resonance condition, i.e., LC resonance.

By controlling the slot lengths, the distance between the slots, and the length of overlap region between the slots, a resonance condition is formed such that the ground plane across a specific frequency bandwidth has a larger electrical length. The resonance of the LC section formed by the slots should then coincide with the frequency of the antenna to be optimized. As will be appreciated by those skilled in the art, the two slots can vary in length but should not be so long as to cut completely thru the ground plane (i.e., bisect the ground plane). Additionally, three or more slots can be used to extend the electrical length of the ground plane. As more slots are added the RF currents are forced to meander back and forth around the slot sections as current flows from the antenna to the opposite end of the ground plane. In some configurations, the slots can be angled with respect to the sides of the ground plane, so that they are positioned such that the slot is not perpendicular to one side of the ground plane or parallel to a side of the ground plane. Thus, slots can be, for example, angled slots, non-parallel slots, curved slots, and slots that are not linear, such as “L” shaped slots. The ground plane can be flexible.

The first u-axis slot 452 and the second u-axis slot 454 are separated by a portion of the ground plane between the slots 456. The first u-axis slot 452 does not extend all the way from the right side of the ground plane to the left side of the ground plane, and thus does not bisect the ground plane. Similarly, the second u-axis slot 454 does not extend all the way from the left side of the ground plane to the right side of the plane. The resulting illustrated ground plane has an area of 2800 mm², but has a perimeter length greater than 230 mm. In some configurations, the perimeter length is greater than 300 mm. In still other configurations, the perimeter length is greater than 350 mm. An elongated transmission line 420 is provided that has a front section 422 and a rear section 424 the elongated transmission line 420 is electrically connected to the antenna. A gap 426 is positioned between the elongated transmission line 420 and first horizontal slot 452 in the ground plane 450. The width of the gap 426 is determined by the impedance of the transmission line 420 which can be etched into the ground plane. Where the transmission line is 50 ohms, the gap width would be, for example, 0.5 mm to 1.0 mm in width.

The combination of the first u-axis slot 452 and the second u-axis slot 454 represent an LC circuit which results in an increased electrical length of the ground plane, which in turn results in a higher efficiency of the antenna. Turning to FIG. 4B, a dual resonance response 460 has a return loss of greater than 20 dB at 810 and 940 MHz. The efficiency 470 shown in FIG. 4C is 74% at both frequencies.

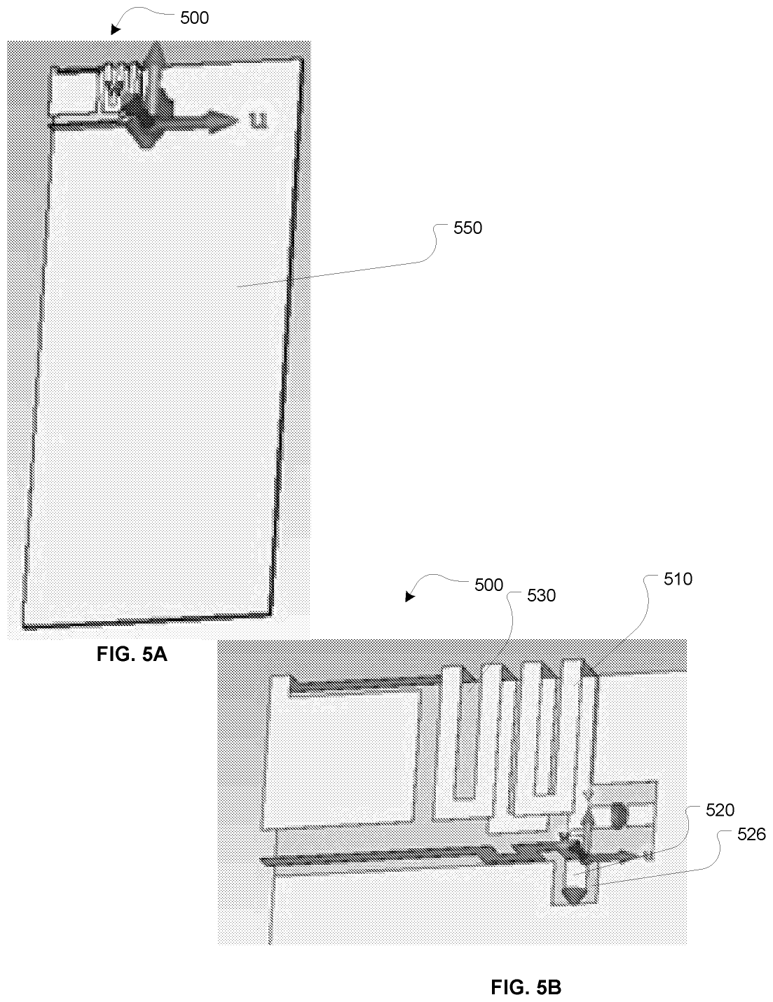

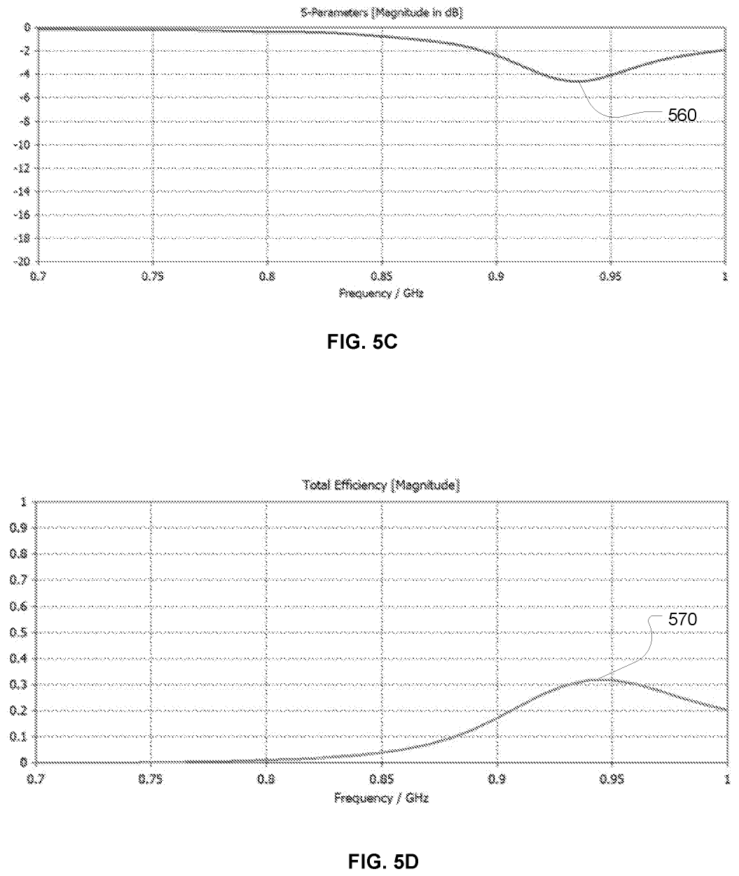

FIGS. 5A-B illustrate a ceramic NB-IoT antenna 500 positioned on a board 530 with the transmission line 510 reduced to allow for a slot configuration to be cut into the ground plane 550. When the ground plane is reduced, the efficiency of the antenna drops. A transmission line 520 is provided that is electrically connected to the antenna. A gap 526 is positioned between the transmission line 520 and the ground plane 550. The transmission line 520 is shortened to about 2 mm in length.

Turning to FIG. 5C, a resonance response 560 has a return loss of greater than 4 dB at about 940 MHz. The efficiency 570 shown in FIG. 5C is about 30% at about 940 MHz.

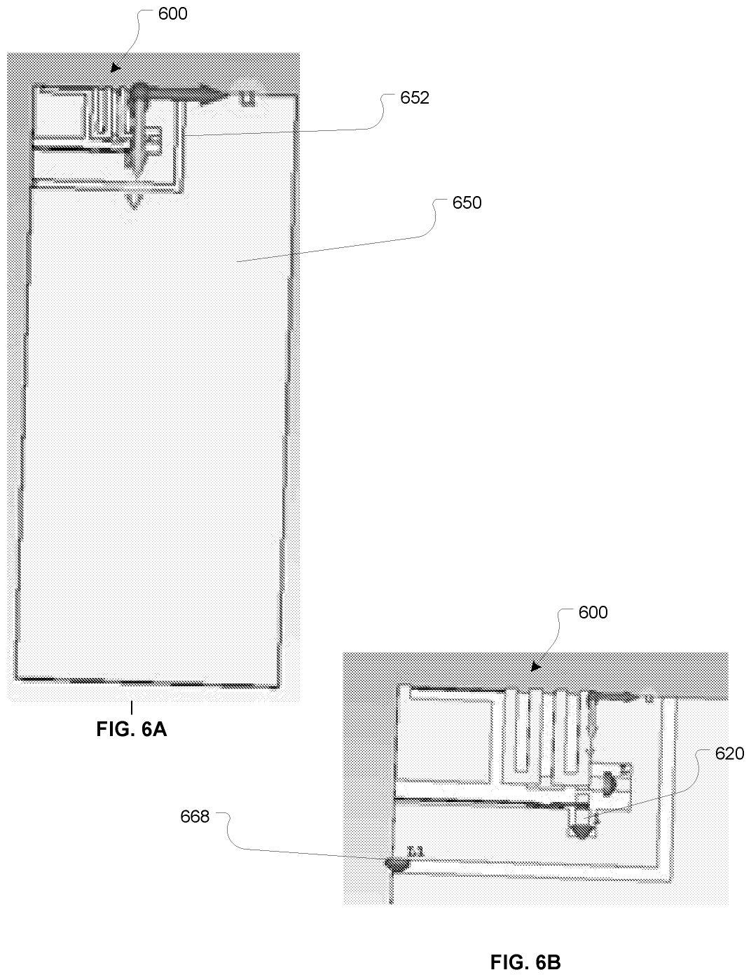

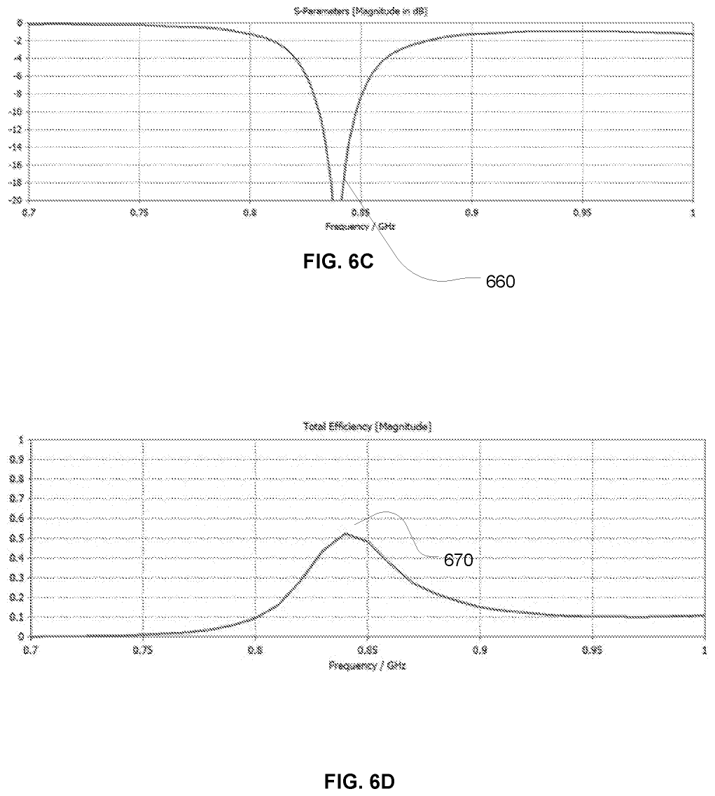

FIGS. 6A-B shows a ceramic NB-IoT antenna 600 on the 80 mm board with the transmission line 620 reduced and an L-shaped slot 652 added to isolate the ground plane 650 in the vicinity of the antenna 600 from the rest of the ground plane 650. The L-shaped slot 652 is introduced to isolate the antenna 600 from the majority of the ground plane 650. An inductor 668 is positioned in the slot region and used to connect the two sections of the ground plane. The combination of the L-shaped slot 652 and the inductor 668 represent an LC circuit with the result being an increase in the electrical length of the ground plane 650, which in tum results in higher efficiency. The inductor 668 value can have a 10 nH with 0.4Ω resistance. The return loss 660 is greater than 20 dB at 840 MHz and the efficiency 670 is 51% at the same frequency. Comparing the result of this antenna configuration with the antenna configuration without the slot illustrated in FIG. 3A this configuration has a 1.2 dB increase in antenna efficiency.

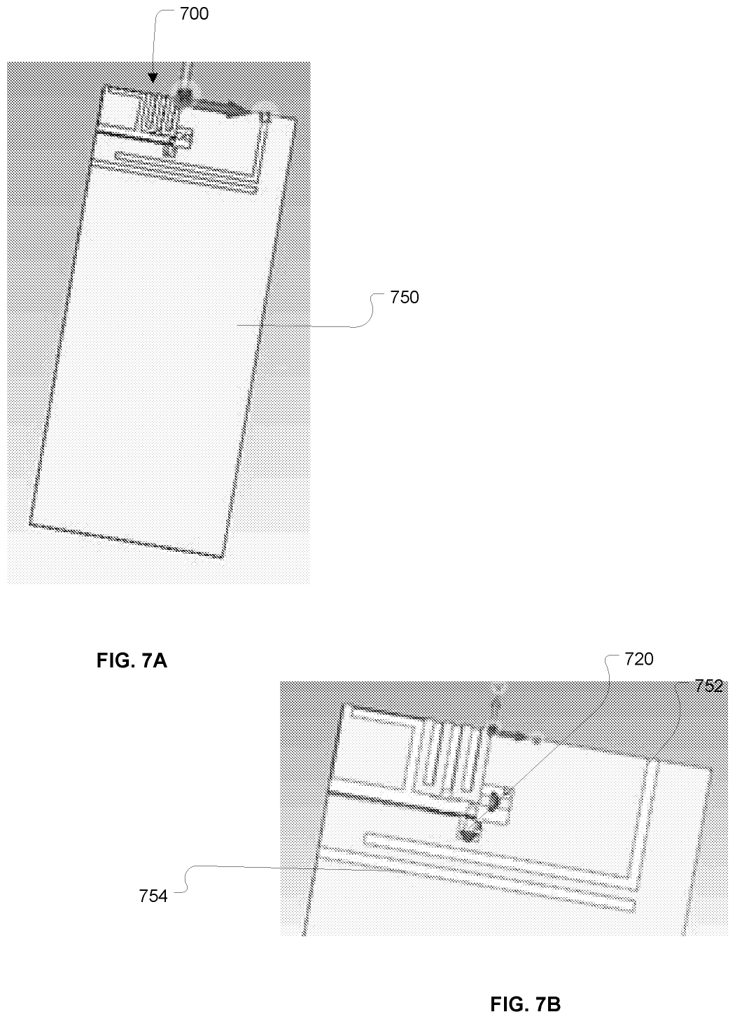

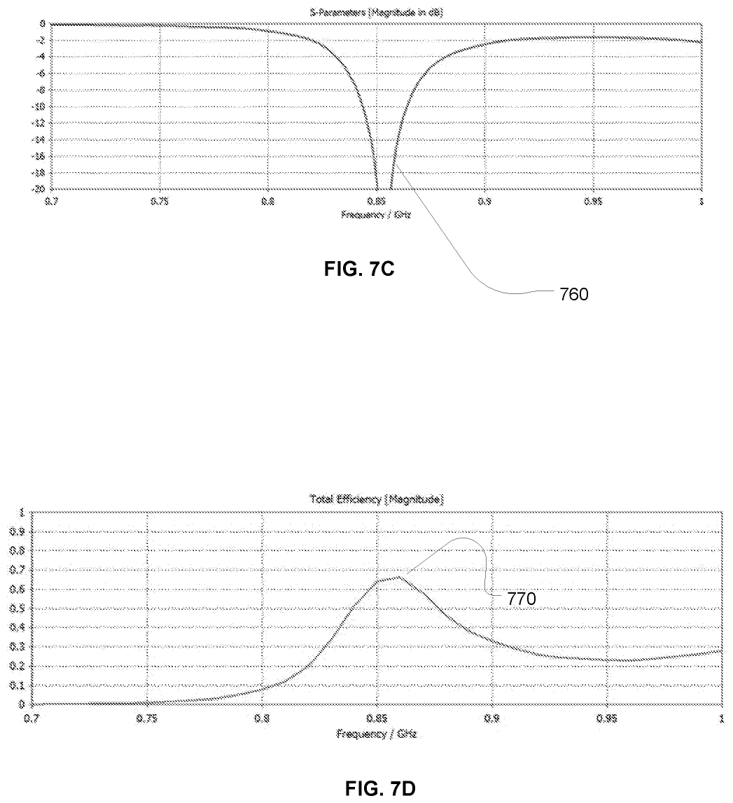

FIGS. 7A-B illustrates a ceramic NB-IoT antenna on 35 mm by 80 mm ground plane 750 with reduced transmission line 720 and two slot configuration cut to alter the ground plane 750 geometry. The two slots 752, 754 have a parallel section. A first slot 752 is an L-shaped slot, and the second slot 754 is linear. The combination of the two slots 752, 754 represents an LC circuit with the result being an increase in the electrical length of the ground plane 750, which results in a higher efficiency of the antenna 700.

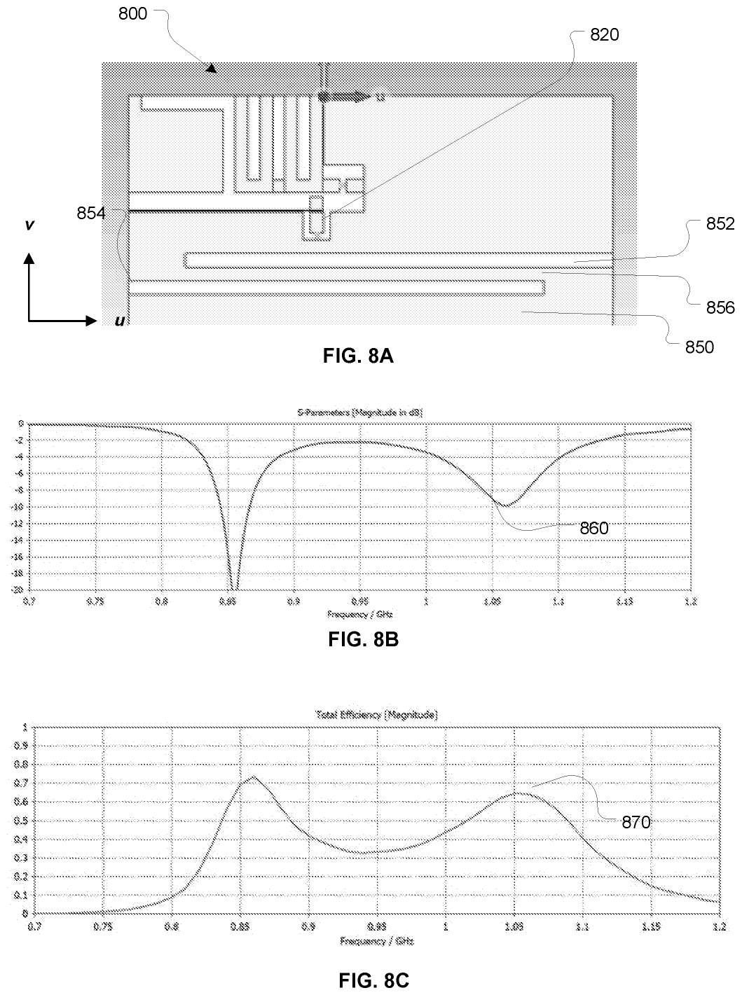

As will be appreciated by those skilled in the art, the antenna is well matched at 855 MHz with a return loss 760 shown in FIG. 7C greater than 20 dB at about 850 MHz and an efficiency 770 shown in FIG. 7D of 66% at 850 MHz. Comparing the result of antenna configuration of FIG. 8A-C with the antenna configuration without the slot illustrated in FIG. 3A, the configuration of FIG. 8 provides a 2.4 dB increase in antenna efficiency.

FIG. 8A illustrates an NB-IoT antenna on a portion of a 35 mm by 80 mm ground plane 850 in a configuration with reduced transmission line 820 and a two parallel slot 852, 854 cut to alter the ground plane geometry, with the two slots parallel to each other. The slots are positioned closer to the antenna than the configuration in FIG. 4A which has an elongated transmission line. A dual resonance response has a return loss 860 of greater than 20 dB at 855 MHz and 1060 MHz. The efficiency 870 is 73% at 855 MHz and 64% at 1060 MHz.

In use, single or multiple slot configurations can be used which are grouped close to an antenna. The use of the slot configurations disclosed makes integration of an antenna into a device easier. The use of desired slot geometry and placement of the inductor in the ground plane facilitates the use of antennas in a wider variety of applications. By slightly increasing the area assigned to the antenna, antenna efficiency is improved when the PCB would not otherwise be long enough for good efficiency performance.

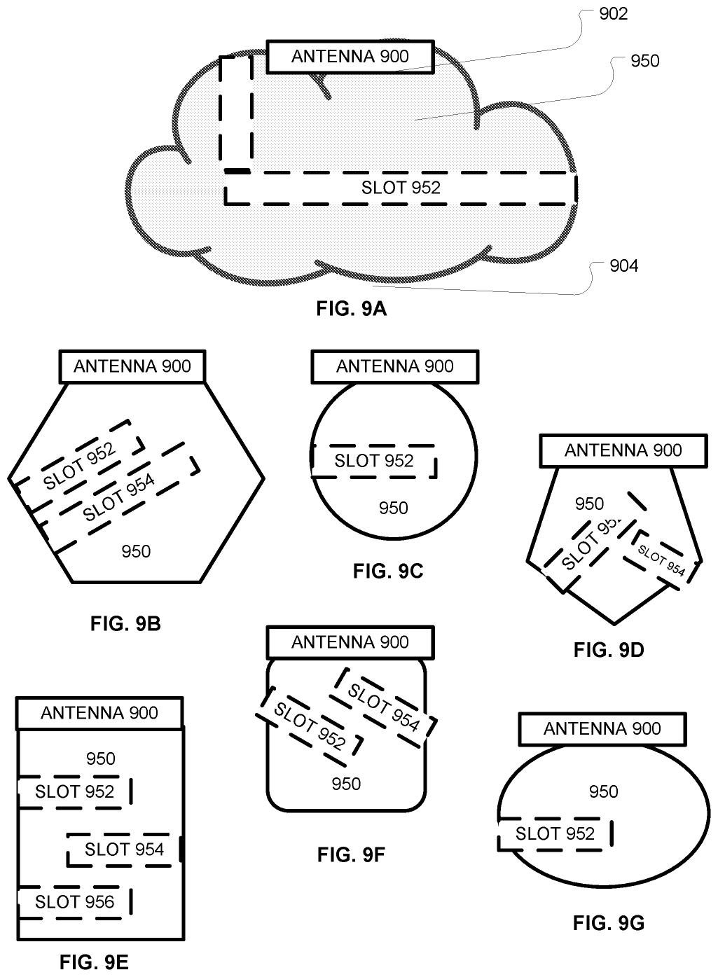

Turning to FIGS. 9A-G, a variety of ground plane 950 shapes are depicted. Ground plane shapes include, but are not limited to, irregular, hexagonal, pentagonal, round, oval, square and rectangular. One or more slots 952, 954, 956 can be provided. The slots can have a variety of shapes and configurations and orientations towards each other when more than one slot is provided. The slots can be positioned along any edge of the ground plane between a first location 902 where an antenna 900 is engaged and a second location 904 which is away from the antenna engagement location (first location 902). The slots can take a variety of positions and configurations without departing from the scope of the disclosure. As will be appreciated by those skilled in the art, the antenna can take a variety of shapes and operational frequencies without departing from the scope of the disclosure.

In use, a ground plane can be optimized for use with an antenna and an installation location by selecting a shape of the ground plane, and a flexibility of the ground plane; identifying an antenna position on the ground plane wherein the antenna position is near an edge of the ground plane; determining an electrical length of the ground plane from the antenna position to a location on the ground plane farthest from the antenna position; and positioning one or more slots on the ground plane between the antenna position and the location on the ground plane farthest from the antenna position. Additionally, an LC circuit can be positioned either in parallel or in series on the ground plane.

A Q value, i.e., quality factor, or bandwidth of the LC circuit provided with the antenna(s) and ground plane configurations is selected to increase the electrical length of the ground plane at the low frequency band by a specific fraction of a wavelength and to increase the electrical length of the ground plane by a different specific fraction of a wavelength at the high frequency band.

The methods and configurations disclosed allow an LC value to be chosen that optimizes a low band frequency performance without decreasing the efficiency of the antenna at high band frequencies. As will be appreciated by referring back to FIG. 1B, the ground plane length that is optimal for efficiency at a high band frequencies is not the same ground plane length that is optimal for low band frequencies. The slot configurations and LC circuit allows optimization of both bands simultaneously.

The use of the ground plane configurations disclosed allows for optimization of both the low band frequency and the high band frequency of a dual band antenna by proper selection of LC characteristics, i.e., slot length, overlap region between slots, value selected for inductor. For dual frequency band antennas different electrical lengths would be used at the low band frequency and the high band frequency.

The ground plane layout can be provided as part of a kit which includes an antenna.

While certain embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An antenna system comprising:
an antenna configurable to operate in a range of 600 MHz to 1000 MHz at an efficiency greater than 70%; and
a ground plane electrically connected to the antenna at an attachment location of the antenna, the ground plane having a length from the attachment location to a farthest edge of the ground plane of less than 100 mm.

2. The antenna system of claim 1 wherein the ground plane comprises an LC circuit.

3. The antenna system of claim 2 wherein the LC circuit comprises a plurality of slots positioned on the ground plane.

4. The antenna system of claim 2 wherein a capacitor is added to an inductor such that the LC circuit is at least one of a series LC circuit or a parallel LC circuit and wherein the LC circuit is positioned across at least one slot of the plurality of slots.

5. The antenna system of claim 1 further comprising at least one of a capacitor and a resistor.

6. The antenna system of claim 2 wherein the LC circuit further comprises an L-shaped slot and an inductor.

7. The antenna system of claim 6 further comprising two or more inductors wherein the two or more inductors are attached across the L-shaped slot at two or more locations along the length of the L-shaped slot.

8. The antenna system of claim 6 where the L-shaped slot disconnects a first portion of the ground plane from a second portion of the ground plane.

9. The antenna system of claim 1 wherein the antenna is connected to a transmission line.

10. The antenna system of claim 9 wherein the transmission line has a length between between 2 mm and about 60 mm.

11. The antenna system of claim 1 wherein the ground plane has a first exterior dimension of about 35 mm or less and a second dimension of about 80 mm or less.

12. The antenna system of claim 1 wherein the antenna has a low frequency resonance and a high frequency resonance.

13. The antenna system of claim 12 wherein the ground plane comprises an LC circuit.

14. The antenna system of claim 13 wherein the LC circuit further comprises a plurality of slots positioned on the ground plane.

15. The antenna system of claim 14 wherein the LC circuit comprises an L-shaped slot and an inductor.

16. A ground plane for use with an antenna comprising:
a ground plane having a longest exterior dimension of less than 120 mm;
a first slot extending into the ground plane from a first location on the perimeter of the ground plane; and
a second slot extending into the ground plane from a second location on the perimeter of the ground plane, at least a portion of the first slot extending adjacent at least a portion of the second slot.

17. The ground plane of claim 16 wherein the ground plane has a first exterior dimension of about 35 mm or less and a second exterior dimension of about 80 mm or less.

18. The ground plane of claim 16 wherein the ground plane has a shape selected from square, rectangular, circular, and oval.

19. The ground plane of claim 16 wherein the ground plane has 5 or more sides.

20. The ground plane of claim 16, wherein the longest exterior dimension of the ground plane is less than about 100 mm.

21. The ground plane of claim 20 wherein the first slot is linear and the second slot is L-shaped.

22. The ground plane of claim 20 wherein the first slot electromagnetically couples with the second slot.

23. The ground plane of claim 16 wherein the ground plane comprises an LC circuit comprising a slot and an inductor.

24. A method of optimizing a ground plane for use with an antenna comprising:
selecting a shape of the ground plane;
identifying an antenna position on the ground plane wherein the antenna position is near an edge of the ground plane; and
positioning one or more slots on the ground plane between the antenna position and the location on the ground plane farthest from the antenna position.

25. The method of optimizing a ground plane of claim 24 further comprising positioning an LC circuit on the ground plane.

26. The method of optimizing a ground plane of claim 25 further comprising selecting a bandwidth for the LC circuit, wherein the bandwidth is selected to optimize a low band frequency for the antenna without decreasing efficiency of a high band frequency.
